(19) United States
(12) Patent Application Publication
(10) Pub. No.: US 2026/0129681 A1
(43) Pub. Date: May 7, 2026

(54) SYSTEM AND METHOD FOR WIRELESS COMMUNICATIONS UNDER A MULTIPLE FEATURE DELAY

(71) Applicant: NXP USA, Inc., AUSTIN, TX (US)

(72) Inventors: Liwen Chu, San Ramon, CA (US); Rui Cao, Sunnyvale, CA (US); Kiseon Ryu, San Diego, CA (US); Huizhao Wang, San Jose, CA (US); Hongyuan Zhang, Fremont, CA (US)

(21) Appl. No.: 19/375,003

(22) Filed: Oct. 30, 2025

Related U.S. Application Data
(60) Provisional application No. 63/714,921, filed on Nov. 1, 2024.
(60) Provisional application No. 63/846,741, filed on Jul. 18, 2025.

(51) Int. Cl. H04W 74/0816; H04W 52/02; H04W 84/12

(52) U.S. Cl. CPC H04W 74/0816; H04W 52/0203; H04W 84/12

(57) ABSTRACT

Embodiments of a method and apparatus for wireless communications are disclosed. In an embodiment, a wireless device includes a controller configured to enable features that are used in a transmit opportunity (TXOP) and a wireless transceiver configured to announce delays associated with the enabled features that are used in the TXOP and to conduct wireless communications with the enabled features in the TXOP.

### CROSS-REFERENCE TO RELATED APPLICATIONS

This application is entitled to the benefit of U.S. Provisional Patent Application Ser. No. 63/714,921, filed on Nov. 1, 2024 and U.S. Provisional Patent Application Ser. No. 63/846,741, filed on Jul. 18, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to enable features that are used in a transmit opportunity (TXOP) and a wireless transceiver configured to announce delays associated with the enabled features that are used in the TXOP and to conduct wireless communications with the enabled features in the TXOP. Other embodiments are also disclosed.

In an embodiment, the wireless device acts as a TXOP responder, and the TXOP responder's delay includes a multiple feature delay, which is a maximum value of the delays associated with the enabled features that are used in the TXOP.

In an embodiment, both a TXOP holder and the TXOP responder treat the multiple feature delay as a delay of the enabled features that are used by the TXOP responder in the TXOP.

In an embodiment, the multiple feature delay is figured out or deciphered by the TXOP responder and the TXOP holder.

In an embodiment, the enabled features include at least two of dynamic subband operation (DSO), dynamic power save (DPS), enhanced multilink single-radio (EMLSR), and non-primary channel access (NPCA).

In an embodiment, a delay associated with the DSO includes a DSO switchback delay from a DSO subband to a DSO primary channel, a delay associated with the DPS includes a DPS transition delay from a high capacity (HC) mode to a low capacity (LC) mode, a delay associated with the EMLSR includes an EMLSR transition delay from a frame exchange operation to a listening operation, and a delay associated with the NPCA includes an NPCA switchback delay from an NPCA primary channel to a primary channel.

In an embodiment, the wireless device acts as a TXOP responder, and the TXOP responder's delay includes a multiple feature delay, which is a maximum value of the DSO switchback delay, the DPS transition delay, the EMLSR transition delay, and the NPCA switchback delay.

In an embodiment, the wireless device acts as a TXOP responder that uses the NPCA with at least one of the DPS and the EMLSR being allowed to be used simultaneously, and the TXOP responder's delay includes a multiple feature delay, which is a maximum value of the DPS transition delay and the EMLSR transition delay if the wireless device does not switch to the primary channel.

In an embodiment, the wireless device acts as a TXOP responder that uses the NPCA with at least one of the DPS and the EMLSR being allowed to be used simultaneously, and the TXOP responder's delay includes a multiple feature delay, which is a maximum value of the DPS transition delay, the EMLSR transition delay, and the NPCA switchback delay if the wireless device switches to the primary channel.

In an embodiment, the enabled features include at least two of dynamic subband operation (DSO), dynamic power save (DPS), dynamic unavailability operation (DUO), enhanced multilink single-radio (EMLSR), and non-primary channel access (NPCA).

In an embodiment, a wireless station (STA), which is affiliated with a same non-access point (AP) multi-link device (MLD) as the wireless device and is in an EMLSR link, uses the multiple feature delay as its EMLSR transition delay.

In an embodiment, the wireless device is compatible with an Institute of Electrical and Electronics Engineers (IEEE) 802.11 protocol.

In an embodiment, a method for wireless communications includes at a wireless device, enabling features that are used in a transmit opportunity (TXOP) and at the wireless device, announcing delays associated with the enabled features that are used in the TXOP and conducting wireless communications with the enabled features in the TXOP.

In an embodiment, the wireless device acts as a TXOP responder, and the TXOP responder's delay includes a multiple feature delay, which is a maximum value of the delays associated with the enabled features that are used in the TXOP.

In an embodiment, both a TXOP holder and the TXOP responder treat the multiple feature delay as a delay of the enabled features that are used by the TXOP responder in the TXOP.

In an embodiment, the multiple feature delay is figured out or deciphered by the TXOP responder and the TXOP holder.

In an embodiment, the enabled features include at least two of dynamic subband operation (DSO), dynamic power save (DPS), enhanced multilink single-radio (EMLSR), and non-primary channel access (NPCA).

In an embodiment, a delay associated with the DSO includes a DSO switchback delay from a DSO subband to a DSO primary channel, a delay associated with the DPS includes a DPS transition delay from a high capacity (HC) mode to a low capacity (LC) mode, a delay associated with the EMLSR includes an EMLSR transition delay from a frame exchange operation to a listening operation, and a delay associated with the NPCA includes an NPCA switchback delay from an NPCA primary channel to a primary channel.

In an embodiment, the wireless device acts as a TXOP responder, and the TXOP responder's delay includes a multiple feature delay, which is a maximum value of the DSO switchback delay, the DPS transition delay, the EMLSR transition delay, and the NPCA switchback delay.

In an embodiment, the wireless device acts as a TXOP responder that uses the NPCA with at least one of the DPS and the EMLSR being allowed to be used simultaneously, and the TXOP responder's delay includes a multiple feature delay, which is a maximum value of the DPS transition delay, the EMLSR transition delay, and the NPCA switchback delay if the wireless device switches to the primary channel.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates an Ultra High Reliability (UHR) Enhanced Multi-Link (EML) capabilities subfield format in accordance with example embodiments.

FIG. 5 illustrates a UHR EML capabilities subfield format in accordance with example embodiments.

FIG. 6 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

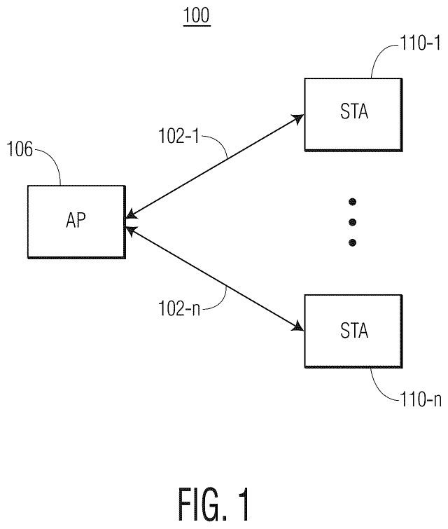

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, ..., 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

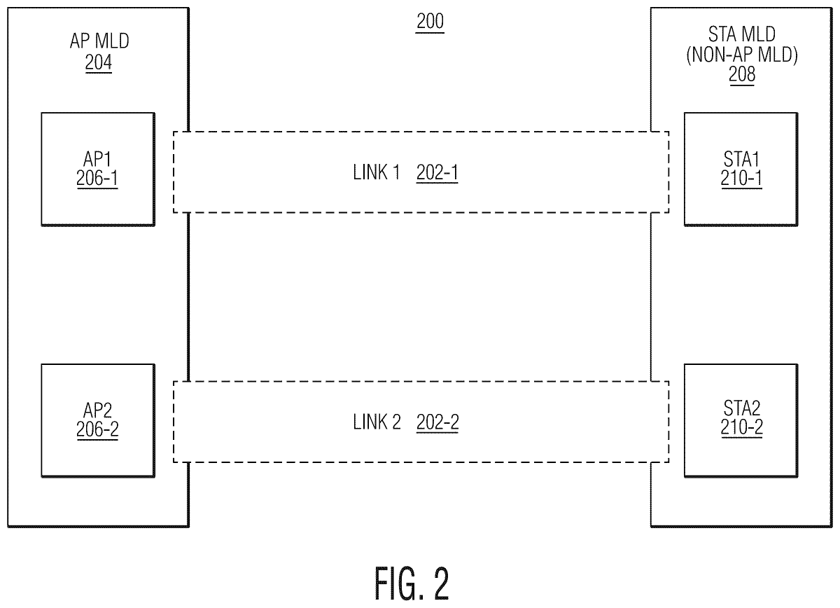

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

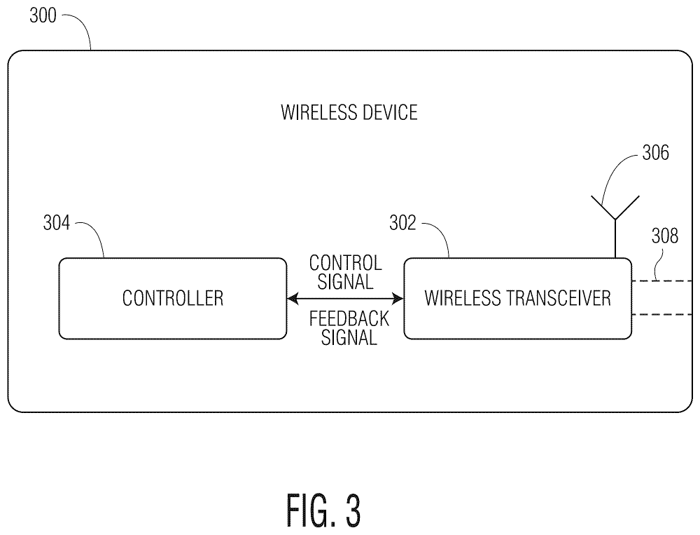

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

In accordance with an embodiment of the disclosure, the controller 304 is configured to enable multiple features that are used in a transmit opportunity (TXOP), and the wireless transceiver 302 is configured to announce delays associated with the enabled features that are used in the TXOP and to conduct wireless communications (for example, taking part in the operation or management of wireless communications, such as to participate in frame exchanges (e.g., to transmit and receive frames)) with the enabled features in the TXOP, for example, through the at least one antenna 306.

In some embodiments, the wireless device 300 acts as a TXOP responder, and the TXOP responder's delay includes a multiple feature delay, which is a maximum value of the delays associated with the enabled features that are used in the TXOP (e.g., wireless communications can be conducted under or with the multiple feature delay).

In some embodiments, both a TXOP holder and the TXOP responder treat the multiple feature delay as a delay of the enabled features that are used by the TXOP responder in the TXOP.

In some embodiments, the multiple feature delay is figured out or deciphered by the TXOP responder and the TXOP holder.

In some embodiments, the enabled features include at least two of dynamic subband operation (DSO), dynamic power save (DPS), enhanced multilink single-radio (EMLSR), and non-primary channel access (NPCA).

In some embodiments, a delay associated with the DSO includes a DSO switchback delay from a DSO subband to a DSO primary channel, a delay associated with the DPS includes a DPS transition delay from a high capacity (HC) mode to a low capacity (LC) mode, a delay associated with the EMLSR includes an EMLSR transition delay from a frame exchange operation to a listening operation, and a delay associated with the NPCA includes an NPCA switchback delay from an NPCA primary channel to a primary channel.

In some embodiments, the wireless device 300 acts as a TXOP responder, and the TXOP responder's delay includes a multiple feature delay, which is a maximum value of the DSO switchback delay, the DPS transition delay, the EMLSR transition delay, and the NPCA switchback delay (e.g., wireless communications can be conducted under or with the multiple feature delay).

In some embodiments, the wireless device 300 acts as a TXOP responder that uses the NPCA with at least one of the DPS and the EMLSR being allowed to be used simultaneously, and the TXOP responder's delay includes a multiple feature delay, which is a maximum value of the DPS transition delay and the EMLSR transition delay if the wireless device does not switch to the primary channel (e.g., wireless communications can be conducted under or with the multiple feature delay).

In some embodiments, the wireless device 300 acts as a TXOP responder that uses the NPCA with at least one of the DPS and the EMLSR being allowed to be used simultaneously, and the TXOP responder's delay includes a multiple feature delay, which is a maximum value of the DPS transition delay, the EMLSR transition delay, and the NPCA switchback delay if the wireless device switches to the primary channel.

In some embodiments, the enabled features include at least two of dynamic subband operation (DSO), dynamic power save (DPS), dynamic unavailability operation (DUO), enhanced multilink single-radio (EMLSR), and non-primary channel access (NPCA).

In some embodiments, a wireless station (STA), which is affiliated with a same non-access point (AP) multi-link device (MLD) as the wireless device 300 and is in an EMLSR link, uses the multiple feature delay as its EMLSR transition delay.

In some embodiments, the wireless device 300 is compatible with an Institute of Electrical and Electronics Engineers (IEEE) 802.11 protocol.

In some embodiments, the wireless device 300 includes a wireless multi-link device (MLD), and the wireless transceiver 302 is further configured to conduct frame exchanges with a second wireless MLD through wireless links between the wireless MLD and the second wireless MLD.

In some implementations, an AP/STA may enable multiple features/modes of Dynamic Power Save (DPS), dynamic subband operation (DSO), dynamic unavailability operation (DUO), non-primary channel access (NPCA). In some embodiments, a STA MLD may enable enhanced multilink single-radio (EMLSR or EMLR). Padding, initial control frame (ICF)/initial control response (ICR) for such deployment and rules related to the ending of the Transmit opportunity (TXOP) need to be addressed.

In some embodiments, when at least two of DPS, DSO, EMLR are used by a TXOP responder, the TXOP responder's delay is the maximum value of all the delays whose features are used. Additionally, in some embodiments, the non-AP MLD's delay from a frame exchange operation to a listening operation for EMLSR in all the EMLSR links after the frame exchanges is the maximum value of all the delays whose features are used.

In some embodiments, when NPCA and at least one of the DPS, EMLSR is enabled, when a TXOP responder switches back to the primary channel from the NPCA primary channel, the TOXP responder treats or decides the maximum value of all the delays whose features are used as its delay.

Some example operations (e.g., behaviors after the ending of frame exchanges), for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, if/when a TXOP responder, which performs frame exchanges in a TXOP with a TXOP holder, satisfies at least two of:
1. being in a frame exchange mode of EMLSR;
2. being in the NPCA primary channel;
3. being in a high capacity (HC) mode of DPS; and
4. being in the DSO subband,
   a TXOP holder and the TXOP responder treat or decide the delay of each used feature in the TXOP as the maximum value of the following delays (e.g., for switching back to the primary channel if required, the transition to low capacity (LC) mode if required, switching back to the primary channel from the NPCA primary channel if required):
1. the DSO switch back delay if the TXOP responder is in the DSO subband during the TXOP;
2. the NPCA switch back delay if the TXOP responder is in the NPCA primary channel during the TXOP and switches back to the primary channel;
3. the DPS transition delay if the TXOP responder is in the HC mode during the TXOP;
4. the EMLSR transition delay if the TXOP responder uses the EMLSR feature.

Some example operations (e.g., behaviors after the ending of frame exchanges with EMLSR and at least another feature of DSO, DPS, NPCA being used) in the link in which the frame exchanges is conducted by using EMLSR and at least another feature of DPS, NPCA, DSO with another EMLSR link's EMLSR transition delay being influenced, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, if/when a non-AP STA, which is operating in an EMLSR mode on an EMLSR link as the TXOP responder, performs frame exchanges in a TXOP under any of the following conditions:
1. being in the non-primary channel access (NPCA) primary channel;
2. being in high capability (HC) mode for DPS operation;
3. being in the dynamic subband operation (DSO) subband;
   the non-AP MLD with which the non-AP STA is affiliated treats or decides, at the end of the frame exchanges in the TXOP, the EMLSR transition delay related to the TXOP for all the EMLSR links of the non-AP MLD has the same value as the maximum value of the following fields:
1. the NPCA switch back delay field if the TXOP responder switches back to the primary channel;
2. the DPS transition delay field if the TXOP responder switches back to the LC mode;
3. the DSO switchback delay field if the TXOP responder switches back to the primary channel from the DSO subband;
4. the EMLSR transition delay field.

Some implementations of initial control frame (ICF) definition and usage, for example, by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, an ICF addressed to a STA in a TXOP for a feature is one of a request to send (RTS), a multi-user (MU)-RTS, a Buffer Status Report Poll (BSRP) trigger frame, a BSRP non-trigger based (NTB) frame as the first control frame based on the enabled feature, whether the padding delay is required, whether the unavailability information is solicited/reported.

In some embodiments, when the TXOP holder does not receive the responding frame correctly from a STA as the TXOP responder and the frame solicited by the ICF for a feature is the mandatory requirement before the other frame exchanges in the TXOP, the ICF for the TXOP holder needs to be transmitted unless the TXOP holder will not perform the frame exchanges with the TXOP holder or will perform the frame exchanges with the TXOP holder without using the feature.

In some embodiments, after the ICF (i.e., a BSRP Trigger)/ICR exchange with the TXOP responder correctly, the BSRP can still be addressed to the TXOP responder when the frame is not the initial control frame to the TXOP responder in the TXOP, and the response will not include the Multi-STA Block Ack. In such case, the BSRP as the frame that is not in the initial control frame exchange will solicit QoS Null only.

In some embodiments, after the ICF (i.e., a BSRP Trigger)/ICR (a Multi-STA Block Ack+QoS Null) exchange with the TXOP responder correctly, the BSRP can still be addressed to the TXOP responder when the frame is not the initial control frame to the TXOP responder in the TXOP, and the response is still the Multi-STA Block Ack+QoS Null.

In some embodiments, when the TXOP holder does not receive the responding Multi-STA Block Ack+QoS Null correctly from a STA as the TXOP responder and the frame solicited by the ICF for a feature is not the mandatory requirement, e.g., within Multi-STA Block Ack with low latency indication+QoS Null solicited by the BSRP the Multi-STA Block Ack with low latency indication is not received correctly, before the other frame exchanges, the TXOP holder may perform the frame exchanges with transmitting an ICF again.

In some embodiments, in a variant to DUO (dynamic unavailability operation), when a TXOP holder does not receive the responding Multi-STA Block Ack with unavailability information correctly from a STA as the TXOP responder and the frame solicited by the ICF is for the DUO, the TXOP holder needs to transmit ICF with the following exceptions:
1. the TXOP holder may perform the frame exchanges with the TXOP holder if the TXOP solicits acknowledgement from the TXOP responder;
2. the acknowledgement is Multi-STA BA.

Some implementations of enhanced multi-link single radio (EMLSR) improvement, for example, by the wireless communications system 100 depicted in FIG. 1, the AP/STA of the multi-link (ML) communications system 200 in a link depicted in FIG. 2, and/or the wireless device 300 depicted in FIG. 3 are described.

In an observation, the padding delay and transition delay have the value of 0, 32 microseconds (μs), 64 μs, 128 μs, 256 μs while the actual device capability may be less than the announced value, e.g., the maximal difference between the announced value and the device capability will be 127 μs.

In some embodiments, padding delay and transition delay are implemented with smaller unit. In some embodiments, new Action frames are defined for the EMLSR enabling/disabling/updating between a UHR non-AP MLD and a UHR AP MLD.

In some embodiments, a new element is defined to carry the padding delay and transition delay of a UHR EMLSR. In some embodiments, the granularity of the EMLSR Padding Delay and the EMLSR Transition Delay is 4 μs. In some embodiments, a UHR non-AP MLD can announce its EMLSR Padding Delay and EMLSR Transition Delay with the value in scope of 0 to 252 μs.

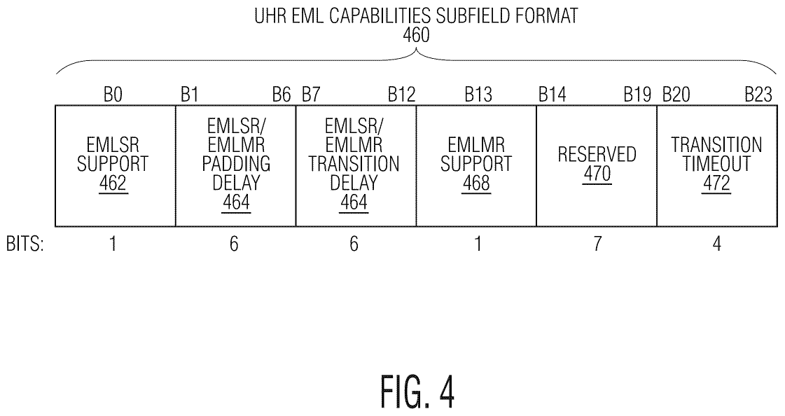

FIG. 4 illustrates a UHR Enhanced Multi-Link (EML) capabilities subfield format 460 in accordance with example embodiments. The UHR EML capabilities subfield format 460 illustrated in FIG. 4 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 4, the UHR EML capabilities subfield format 460 includes an EMLSR Support subfield 462 (e.g., one-bit) that may contain EMLSR Support information, an EMLSR/Enhanced Multi-link Multi-radio (EMLMR) Padding Delay subfield 464 (e.g., six-bit) that may contain EMLSR/EMLMR padding delay information, an EMLSR/EMLMR Transition Delay subfield 466 (e.g., six-bit) that may contain EMLSR/EMLMR transition delay information, an EMLMR Support subfield 468 (e.g., one-bit) that may contain EMLMR support information, a reserved subfield 470 (e.g., seven-bit) that may contain reserved information, and a transition timeout subfield 472 (e.g., four-bit) that may contain transition timeout information.

In some embodiments, the following are used when an EML Capabilities field is transmitted between a UHR AP MLD and a UHR non-AP MLD:
1. the granularity of the EMLSR Padding Delay and the EMLSR Transition Delay is 4 μs.
2. B8 to B10 and B15 (Extended Padding Transition Delay subfield) are repurposed to announce the EMLSR Padding Delay and the EMLSR Transition Delay. In some embodiments, B8 to B10 and B15 are shared by the Padding Delay and the Transition Delay.

In some embodiments, in option 1, the delay n μs equal to 4, 8, 12, 16, 20, . . . 252 μs respectively are announced by (n/4)+4. The values of EMLSR Padding/Transition Delay subfield equal to 12, 20, 36 related to delay 32, 64, 128 are reserved.

In some embodiments, in option 2, the delay n μs equal to 4, 8, 12, 16, 20, 24, 28 μs respectively are announced by (n/4)+4 (5 to 11) (value in EMLSR Padding/Transition Delay subfield+Repurposed bits) respectively. In some embodiments, the delay n μs equal to 36, 40, 44, . . . , 56, 60 μs respectively are announced by (n/4)+3 (12 to 18) respectively. In some embodiments, the delay n μs equal to 68, 72, . . . , 120, 124 μs respectively are announced by (n/4)+2 (19 to 33) respectively. In some embodiments, the delay n μs equal to 132, 136, . . . , 250, 252 μs respectively are announced by (n/4)+1 (34 to 64) respectively.

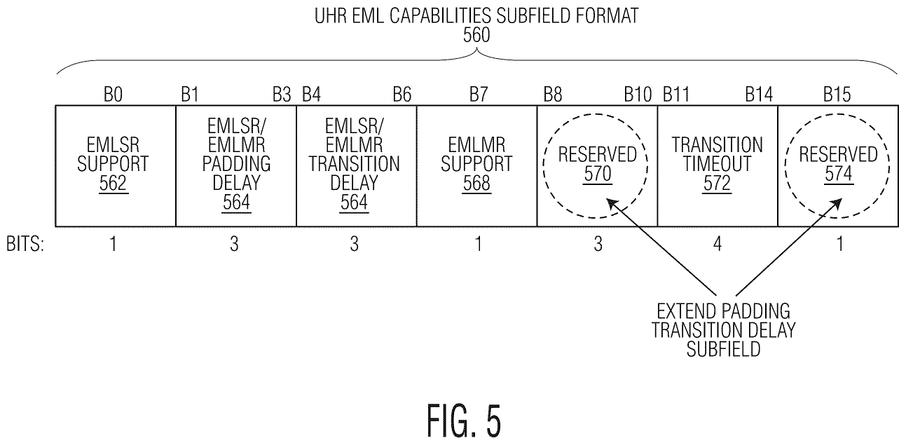

FIG. 5 illustrates a UHR EML capabilities subfield format 560 in accordance with example embodiments. The UHR EML capabilities subfield format 560 illustrated in FIG. 5 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 5, the UHR EML capabilities subfield format 560 includes an EMLSR Support subfield 562 (e.g., one-bit) that may contain EMLSR Support information, an EMLSR/EMLMR Padding Delay subfield 564 (e.g., three-bit) that may contain EMLSR/EMLMR padding delay information, an EMLSR/EMLMR Transition Delay subfield 566 (e.g., three-bit) that may contain EMLSR/EMLMR transition delay information, an EMLMR Support subfield 568 (e.g., one-bit) that may contain EMLMR support information, a reserved subfield 570 (e.g., three-bit) that may contain reserved information, a transition timeout subfield 572 (e.g., four-bit) that may contain transition timeout information, and a reserved subfield 574 (e.g., three-bit) that may contain reserved information. In the embodiment depicted in FIG. 5, the reserved subfield 570 (B8 to B10) and the reserved subfield 574 (B15) are repurposed as Extended Padding Transition Delay subfields and combined with the EMLSR/EMLMR Padding Delay subfield 564 and the EMLSR/EMLMR Transition Delay subfield 566, respectively, to announce the EMLSR padding delay and the EMLSR transition delay, respectively. The reserved subfield 570 (B8 to B10) and the reserved subfield 574 (B15) are shared by the EMLSR Padding Delay and the EMLSR Transition Delay.

In some embodiments, an EHT AP MLD announces whether it supports the improved EMLSR padding/transition delay in an Extended Capabilities element. In some embodiments, if/when the associated EHT AP MLD announces such support, its associated EHT non-AP MLD can use the improved EML Capabilities field for its EMLSR operation.

In some embodiments, a method of performing frame exchanges between a first device and a second device(s) where at least two of DSO, DPS, EMLSR, NPCA are used by the second device includes announcing, by the second device, the delays for various features enabled by itself where the delay for DSO is the DSO switchback delay from a DSO subband to a DSO primary channel, the delay for DPS is the DPS transition delay from a HC mode to a LC mode, the delay for EMLSR is the EMLSR transition delay from a frame exchange operation to a listening operation, the delay for NPCA is the NPCA switchback delay from the NPCA primary channel to the primary channel, and deciding, by the first device and the second device in a TXOP, the multiple feature delay based on the used features in the TXOP by the second device as the TXOP responder. In some embodiments, when the second device as the TXOP responder uses at least two of DPS, DSO, EMLSR being allowed to be used simultaneously, the multiple feature delay, which will be used as the delay for r each used feature after the frame exchanges is the maximum value of the DPS transition delay, the DSO switchback delay, and the EMLSR transition delay. In some embodiments, the EMLSR non-AP MLD with which the second device (the TXOP responder) in an EMLSR link is affiliated uses the multiple feature delay as its EMLSR transition delay. In some embodiments, when the second device as the TXOP responder uses NPCA and at least one of DPS, EMLSR being allowed to be used simultaneously, the multiple feature delay is the maximum value of the DPS transition delay and the EMLSR transition delay if the second device does not switch to the primary channel. In some embodiments, when the second device as the TXOP responder uses EMLSR and at least one of DPS, DSO, NPCA being allowed to be used simultaneously, after the frame exchanges in the TXOP, the EMLSR transition delay of the non-AP MLD with which the TXOP responder is affiliated is the multiple feature delay, i.e., the maximum value of the DPS transition delay, the DSO switch back delay, the NPCA switch back delay if the TXOP responder switches back to primary channel. In some embodiments, when the second device as the TXOP responder uses EMLSR and at least one of DPS, DSO, NPCA being allowed to be used simultaneously, after the frame exchanges in the TXOP, the EMLSR transition delay of the non-AP MLD with which the TXOP responder is affiliated is the maximum value of the DPS transition delay, DSO switch back delay, NPCA switch back delay if the TXOP responder switches back to primary channel, and the EMLSR transition delay.

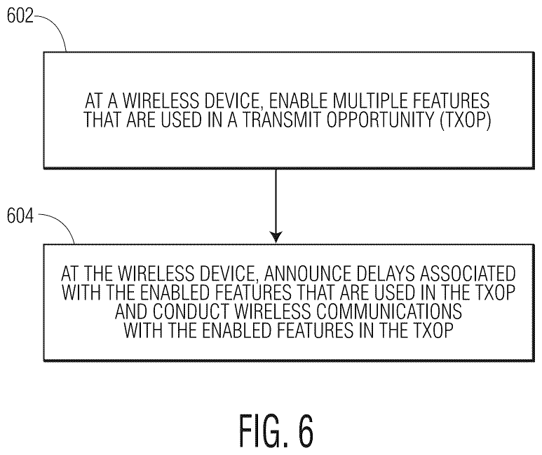

FIG. 6 is a process flow diagram of a method for wireless communications in accordance with example embodiments. At block 602, at a wireless device, multiple features that are used in a transmit opportunity (TXOP) are enabled. At block 604, at the wireless device, delays associated with the enabled features that are used in the TXOP are announced and wireless communications are conducted with the enabled features in the TXOP. In some embodiments, the wireless device acts as a TXOP responder, and the TXOP responder's delay includes a multiple feature delay, which is a maximum value of the delays associated with the enabled features that are used in the TXOP. In some embodiments, both a TXOP holder and the TXOP responder treat the multiple feature delay as a delay of the enabled features that are used by the TXOP responder in the TXOP. In some embodiments, the multiple feature delay is figured out or deciphered by the TXOP responder and the TXOP holder. In some embodiments, the enabled features include at least two of dynamic subband operation (DSO), dynamic power save (DPS), enhanced multilink single-radio (EMLSR), and non-primary channel access (NPCA). In some embodiments, a delay associated with the DSO includes a DSO switchback delay from a DSO subband to a DSO primary channel, a delay associated with the DPS includes a DPS transition delay from a high capacity (HC) mode to a low capacity (LC) mode, a delay associated with the EMLSR includes an EMLSR transition delay from a frame exchange operation to a listening operation, and a delay associated with the NPCA includes an NPCA switchback delay from an NPCA primary channel to a primary channel. In some embodiments, the wireless device acts as a TXOP responder, and the TXOP responder's delay includes a multiple feature delay, which is a maximum value of the DSO switchback delay, the DPS transition delay, the EMLSR transition delay, and the NPCA switchback delay. In some embodiments, the wireless device acts as a TXOP responder that uses the NPCA with at least one of the DPS and the EMLSR being allowed to be used simultaneously, and the TXOP responder's delay includes a multiple feature delay, which is a maximum value of the DPS transition delay, the EMLSR transition delay, and the NPCA switchback delay if the wireless device switches to the primary channel. In some embodiments, the wireless device is compatible with an Institute of Electrical and Electronics Engineers (IEEE) 802.11 protocol. The wireless device may be the same as or similar to an embodiment of the AP 106 and/or the STAs 110-1, . . . , 110-n depicted in FIG. 1, the APs 206-1, 206-2 and/or the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk.

Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to enable a plurality of features that are used in a transmit opportunity (TXOP); and
a wireless transceiver configured to announce a plurality of delays associated with the enabled features that are used in the TXOP and to conduct wireless communications with the enabled features in the TXOP.

2. The wireless device of claim 1, wherein the wireless device acts as a TXOP responder, and wherein the TXOP responder's delay comprises a multiple feature delay, which is a maximum value of the delays associated with the enabled features that are used in the TXOP.

3. The wireless device of claim 2, wherein both a TXOP holder and the TXOP responder treat the multiple feature delay as a delay of the enabled features that are used by the TXOP responder in the TXOP.

4. The wireless device of claim 3, wherein the multiple feature delay is figured out or deciphered by the TXOP responder and the TXOP holder.

5. The wireless device of claim 1, wherein the enabled features comprise at least two of dynamic subband operation (DSO), dynamic power save (DPS), enhanced multilink single-radio (EMLSR), and non-primary channel access (NPCA).

6. The wireless device of claim 5, wherein a delay associated with the DSO comprises a DSO switchback delay from a DSO subband to a DSO primary channel, wherein a delay associated with the DPS comprises a DPS transition delay from a high capacity (HC) mode to a low capacity (LC) mode, wherein a delay associated with the EMLSR comprises an EMLSR transition delay from a frame exchange operation to a listening operation, and wherein a delay associated with the NPCA comprises an NPCA switchback delay from an NPCA primary channel to a primary channel.

7. The wireless device of claim 6, wherein the wireless device acts as a TXOP responder, and wherein the TXOP responder's delay comprises a multiple feature delay, which is a maximum value of the DSO switchback delay, the DPS transition delay, the EMLSR transition delay, and the NPCA switchback delay.

8. The wireless device of claim 6, wherein the wireless device acts as a TXOP responder that uses the NPCA with at least one of the DPS and the EMLSR being allowed to be used simultaneously, and wherein the TXOP responder's delay comprises a multiple feature delay, which is a maximum value of the DPS transition delay and the EMLSR transition delay if the wireless device does not switch to the primary channel.

9. The wireless device of claim 6, wherein the wireless device acts as a TXOP responder that uses the NPCA with at least one of the DPS and the EMLSR being allowed to be used simultaneously, and wherein the TXOP responder's delay comprises a multiple feature delay, which is a maximum value of the DPS transition delay, the EMLSR transition delay, and the NPCA switchback delay if the wireless device switches to the primary channel.

10. The wireless device of claim 1, wherein the enabled features comprise at least two of dynamic subband operation (DSO), dynamic power save (DPS), dynamic unavailability operation (DUO), enhanced multilink single-radio (EMLSR), and non-primary channel access (NPCA).

11. The wireless device of claim 2, wherein a wireless station (STA), which is affiliated with a same non-access point (AP) multi-link device (MLD) as the wireless device and is in an EMLSR link, uses the multiple feature delay as its EMLSR transition delay.

12. The wireless device of claim 1, wherein the wireless device is compatible with an Institute of Electrical and Electronics Engineers (IEEE) 802.11 protocol.

13. A method for wireless communications, the method comprising:
at a wireless device, enabling a plurality of features that are used in a transmit opportunity (TXOP); and
at the wireless device, announcing a plurality of delays associated with the enabled features that are used in the TXOP and conducting wireless communications with the enabled features in the TXOP.

14. The method of claim 13, wherein the wireless device acts as a TXOP responder, and wherein the TXOP responder's delay comprises a multiple feature delay, which is a maximum value of the delays associated with the enabled features that are used in the TXOP.

15. The method of claim 14, wherein both a TXOP holder and the TXOP responder treat the multiple feature delay as a delay of the enabled features that are used by the TXOP responder in the TXOP.

16. The method of claim 15, wherein the multiple feature delay is figured out or deciphered by the TXOP responder and the TXOP holder.

17. The method of claim 13, wherein the enabled features comprise at least two of dynamic subband operation (DSO), dynamic power save (DPS), enhanced multilink single-radio (EMLSR), and non-primary channel access (NPCA).

18. The method of claim 17, wherein a delay associated with the DSO comprises a DSO switchback delay from a DSO subband to a DSO primary channel, wherein a delay associated with the DPS comprises a DPS transition delay from a high capacity (HC) mode to a low capacity (LC) mode, wherein a delay associated with the EMLSR comprises an EMLSR transition delay from a frame exchange operation to a listening operation, and wherein a delay associated with the NPCA comprises an NPCA switchback delay from an NPCA primary channel to a primary channel.

19. The method of claim 18, wherein the wireless device acts as a TXOP responder, and wherein the TXOP responder's delay comprises a multiple feature delay, which is a maximum value of the DSO switchback delay, the DPS transition delay, the EMLSR transition delay, and the NPCA switchback delay.

20. The method of claim 18, wherein the wireless device acts as a TXOP responder that uses the NPCA with at least one of the DPS and the EMLSR being allowed to be used simultaneously, and wherein the TXOP responder's delay comprises a multiple feature delay, which is a maximum value of the DPS transition delay, the EMLSR transition delay, and the NPCA switchback delay if the wireless device switches to the primary channel.
